(19) United States
(12) Patent Application Publication
(10) Pub. No.: US 2026/0267627 A1
(43) Pub. Date: Sep. 10, 2026

(54) DEPLOYMENT TO A SERVING SYSTEM FOR ONLINE, LOW-LATENCY APPLICATIONS

(71) Applicant: Walmart Apollo, LLC, Bentonville, AR (US)

(72) Inventors: Hongwei SHANG, Sunnyvale, CA (US); Nguyen VO, Sunnyvale, CA (US); Nitin YADAV, Oakland, CA (US); Tian ZHANG, San Jose, CA (US); Ajit PUTHENPUTHUSSERY, Edison, NJ (US); Xunfan CAI, Santa Clara, CA (US); Shuyi CHEN, San Jose, CA (US); Prijith CHANDRAN, Milpitas, CA (US); Changsung KANG, San Jose, CA (US)

(73) Assignee: Walmart Apollo, LLC, Bentonville, AR (US)

(21) Appl. No.: 19/074,277

(22) Filed: Mar. 7, 2025

(51) Int. Cl. G06F 8/60; H04L 67/50

(52) U.S. Cl. CPC G06F 8/60; H04L 67/50

(57) ABSTRACT

In some implementations, a device may receive from a user device, a request. The device may determine, based on the request, a retrieval set that includes a plurality of candidate results for the request. The device may generate a plurality of request-result pairs based on the request and the retrieval set. The device may determine relevance outputs for the plurality of request-result pairs using a secondary model that is trained based on a primary model using: (1) an unlabeled dataset that is based on a candidate result set for a historical request, and (2) a margin-based loss function on all candidate result pairs of the candidate result set for the historical request. The device may transmit, to the user device and in accordance with the relevance outputs, data for presentation in a user interface of the user device based on the request.

### BACKGROUND

A server may receive request messages from a user device over a network. The request messages indicate the data that is being requested by the user device. The server may generate data responsive to the request messages, and transmit response messages containing the data to the user device, over the network, to satisfy the requests of the user device. The user device may repeatedly transmit request messages if the response messages from the server contain insufficient, irrelevant, or otherwise unsatisfactory data with respect to the user device's requests. This cycle of request and response uses significant computing resources of the server and the user device in connection with message generation, as well as significant network resources in connection with message communication.

### SUMMARY

A serving system may manage requests from user devices. When a user device sends a request message over a network, the serving system processes this request and generates a response message. This response is then transmitted back to the user device to fulfill its request in real-time. For example, the user device's request may indicate particular data that is desired by the user device, and the serving system may generate the data and transmit a response that contains the data. However, if the response contains insufficient, irrelevant, or otherwise unsatisfactory data, the user device may repeatedly send additional request messages until its demands are fully met. This continuous cycle of request and response requires substantial computing power from both the serving system and the user device for generating and processing messages, and additionally requires significant network resources to handle the communication of these messages.

In some examples, the serving system may generate data for a response by inputting a request into a model that is trained to provide an output based on the request. To achieve low-latency processing of the request, while maintaining acceptable accuracy, the model may be trained using a technique known as knowledge distillation. In knowledge distillation, a large teacher model (e.g., in terms of number of parameters) can be trained using labeled training data. The teacher model may produce outputs having acceptable accuracy, but may be unsuitable for deployment into the serving system because of its large size and significant processing requirements, which could not satisfy the low-latency requirements of online, low-latency applications of the serving system. Thus, a smaller student model can be trained on the same labeled training data, but instead of learning directly from the training data, the student model learns to replicate the outputs of the teacher model.

Labeled training data may have a relatively limited supply compared to unlabeled training data, and therefore the student model, trained using limited labeled training data, may be insufficiently trained and unable to produce highly accurate and relevant outputs. Moreover, each data point in the training data may include data for multiple data fields (e.g., variables). In general, because the student model is trained using data for the multiple data fields, the serving system may also use the multiple data fields when inputting new data points into the student model. Without doing so, the student model may produce lower-quality outputs. However, the full range of data fields may include a significant amount of data, and inputting and processing this large amount of data may consume excessive processing resources and power of the serving system. This may produce additional latency, such that the requirements for online, low-latency applications of the serving system could not be met.

Systems and techniques described herein deploy a secondary (e.g., student) model, trained based on knowledge distillation from a primary (e.g., teacher) model using an unlabeled dataset, in a serving system to satisfy the low-latency requirements of the serving system. Using the secondary model, the serving system is able to reduce the processing resources, power resources, and network resources used by the serving system and user devices in connection with generating and exchanging network messages for online, low-latency applications of the serving system and achieving real-time responses to requests from the user devices.

The knowledge distillation provides a compression technique to compress the behavior of the larger primary model into the smaller secondary model. In some implementations, an offline system may train the primary model using labeled data, generate a large unlabeled dataset (e.g., using raw log data indicating historical user device requests), and train the secondary model based on knowledge distillation from the primary model using outputs from the primary model on the unlabeled dataset and a margin-based loss function (e.g., a margin mean squared error (MSE) loss function). Unlike conventional loss functions that rely on comparisons between data points labeled as relevant and data points labeled as irrelevant for a given request, the margin-based loss function can capture the relevance margin between any pair of data points for a given request, thereby eliminating the need for human labeled data. In this way, the secondary model can learn from the primary model using a much larger dataset. Expanding the dataset used to train the secondary model improves the performance of the secondary model. Accordingly, the secondary model can achieve a performance level that matches, or even surpasses, that of the primary model, while being lightweight enough for online, low-latency applications of serving systems. Moreover, the margin-based loss function enables the secondary model to learn effectively even if fewer data fields in the unlabeled dataset are used for the secondary model than are used for the primary model. This allows the secondary model to produce accurate outputs even if only a subset of data is inputted into the secondary model, thereby using less overall data and reducing consumption of processing resources.

In some implementations, the serving system may use the trained secondary model to generate high-quality data for responding to requests from user devices. For example, the serving system may receive a request from a user device in a network message, and the request may contain a request indicating particular data that is desired by the user device. Continuing with the example, the serving system may use the secondary model to generate high-quality data responsive to the request, and the serving system may transmit a response containing the data in a network message to the user device. By using the secondary model, which is relatively small and lightweight, the serving system may produce outputs with less latency and consuming less processing resources. Due to the way that the secondary model is trained, the serving system may obtain the high-quality data from the secondary model by inputting data reflecting only a subset of possible data fields (e.g., fewer data fields than are used to train the primary model). In this way, data processing in the serving system is reduced, thereby conserving significant processing resources and power. Moreover, due to the way that the secondary model is trained, the serving system may provide more relevant and accurate data to the user device that satisfies the user device's request. By doing so, fewer requests and responses are exchanged in network messages between the serving system and the user device. In this way, the serving system conserves processing resources and network resources that otherwise would be used in connection with processing additional requests, generating additional network messages relating to the additional requests, and transmitting the additional network messages.

Some implementations described herein relate to a system for deploying a secondary model in a serving system that is configured to manage request traffic made in a network by user devices. The system may include one or more memories and one or more processors communicatively coupled to the one or more memories. The one or more processors may be configured to cause the system to receive, from one or more servers, raw log data indicating a historical request and a candidate result set corresponding to the historical request. The one or more processors may be configured to cause the system to generate, based on the historical request and the candidate result set, a first version of an unlabeled dataset that indicates a plurality of request-result pairs using a set of data fields used to train a primary model, and a second version of the unlabeled dataset that indicates the plurality of request-result pairs using a subset of the set of data fields that is smaller in size than the set of data fields. The one or more processors may be configured to cause the system to execute a process for adjusting parameters of a secondary model using the first version of the unlabeled dataset as input into the primary model to provide labels for the plurality of request-result pairs, using the second version of the unlabeled dataset as input into the secondary model, and using a margin-based loss function on all candidate result pairs of the candidate result set for the historical request. The one or more processors may be configured to cause the system to deploy, to the serving system, the secondary model for handling network requests from user devices.

Some implementations described herein relate to a method of managing request traffic in a serving system. The method may include receiving, by a device of the serving system and from a user device, a request. The method may include determining, by the device and based on the request, a retrieval set that includes a plurality of candidate results for the request. The method may include generating, by the device, a plurality of request-result pairs based on the request and the retrieval set. The method may include determining, by the device, relevance outputs for the plurality of request-result pairs using a secondary model that is trained based on a primary model using: (1) an unlabeled dataset that is based on a candidate result set for a historical request, and (2) a margin-based loss function on all candidate result pairs of the candidate result set for the historical request. The method may include transmitting, by the device to the user device and in accordance with the relevance outputs, data for presentation in a user interface of the user device based on the request.

Some implementations described herein relate to an apparatus. The apparatus may include means for generating an unlabeled dataset that includes a plurality of request-result pairs based on a historical request and a candidate result set associated with the historical request. The apparatus may include means for training a secondary model, based on a primary model, using the unlabeled dataset as input to the primary model and to the secondary model, and using a loss function on all candidate result pairs in the candidate result set for the historical request. The apparatus may include means for deploying the secondary model for handling requests from user devices.

### BRIEF DESCRIPTION OF THE DRAWINGS

FIGS. 1A-1F illustrate an example environment for deployment of a secondary model for online, low-latency applications.

FIG. 2 is a diagram of example components of a device associated with deployment of a secondary model for online, low-latency applications.

FIG. 3 is a flowchart of an example process associated with managing request traffic in a serving system.

### DETAILED DESCRIPTION

The following detailed description of example implementations refers to the accompanying drawings. The same reference numbers in different drawings may identify the same or similar elements.

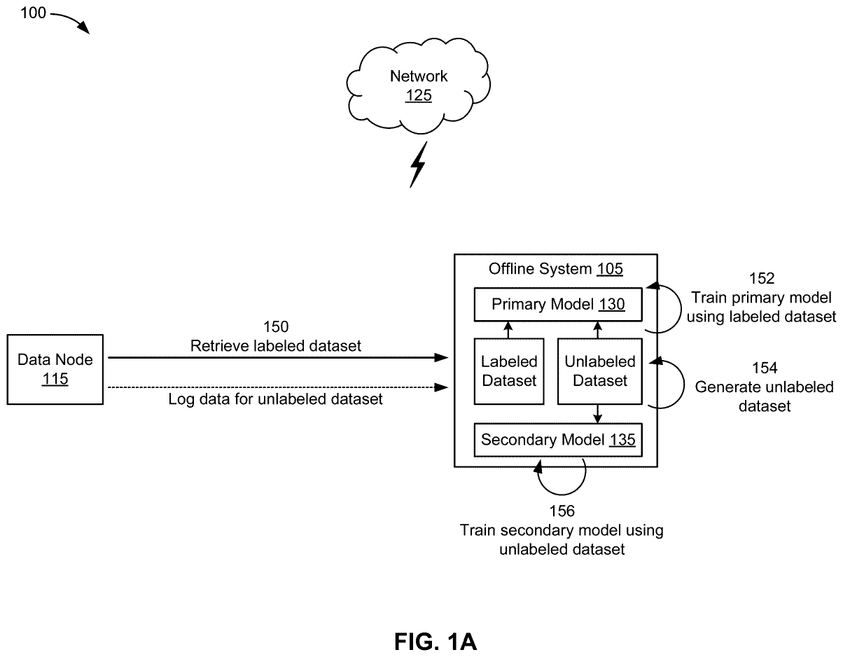

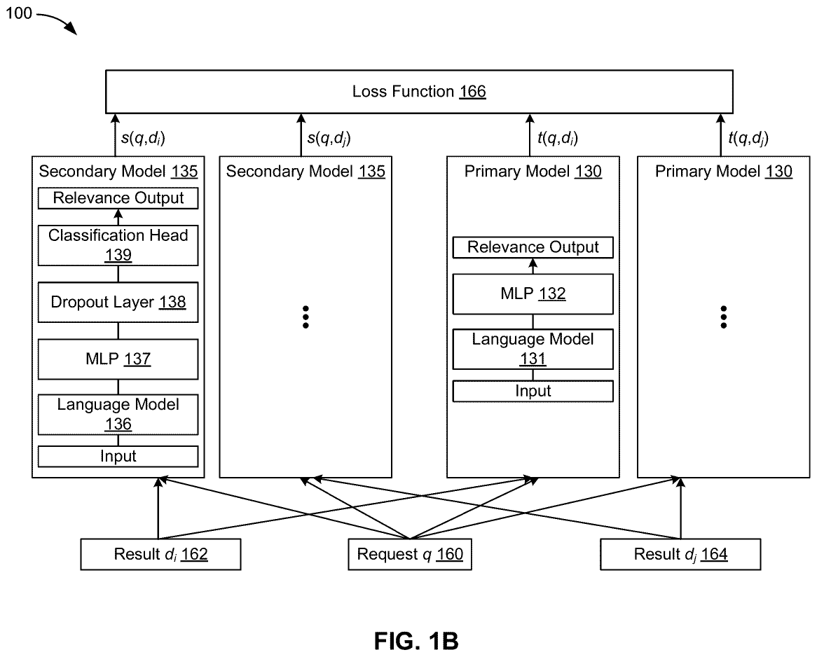

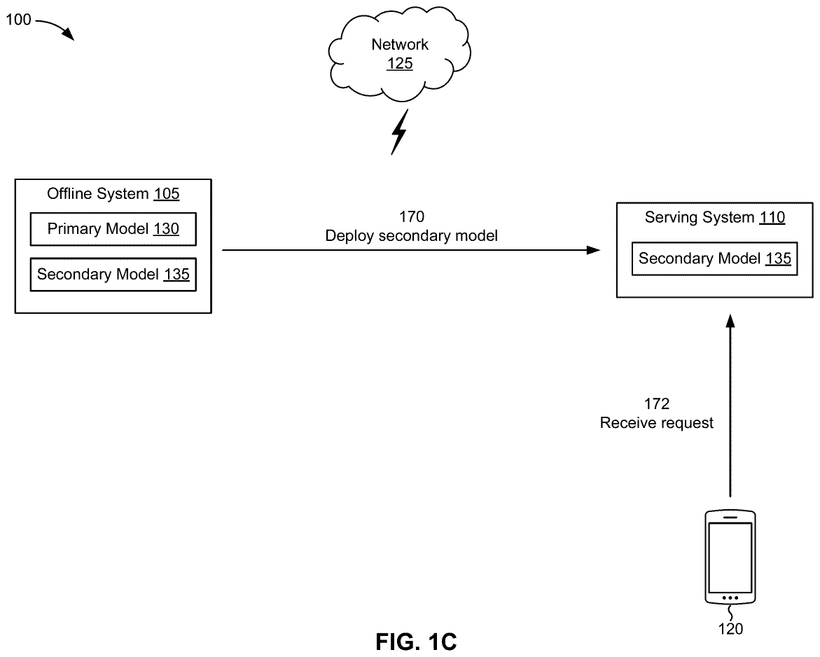

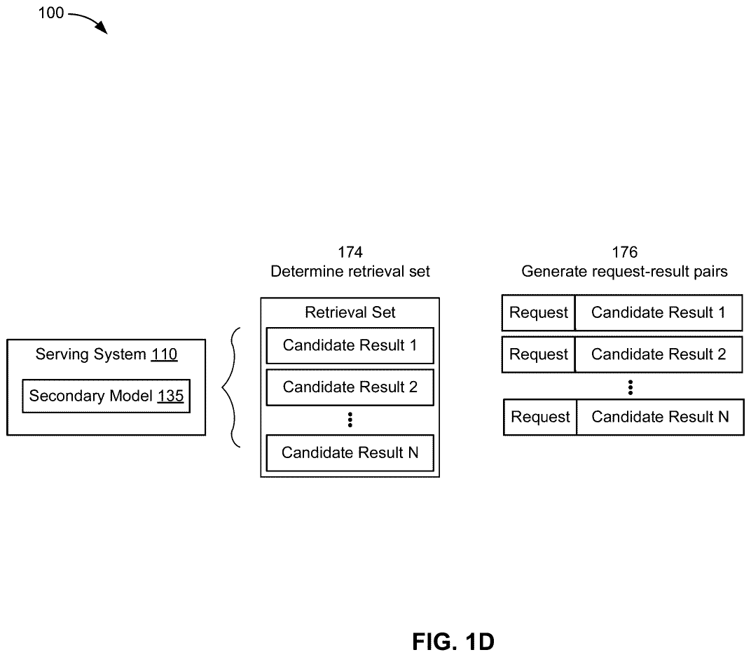

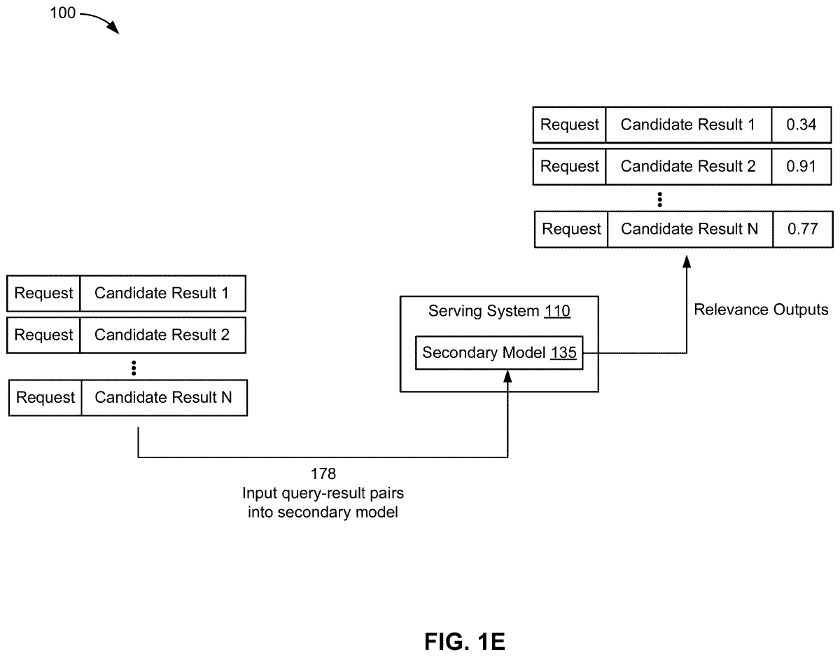

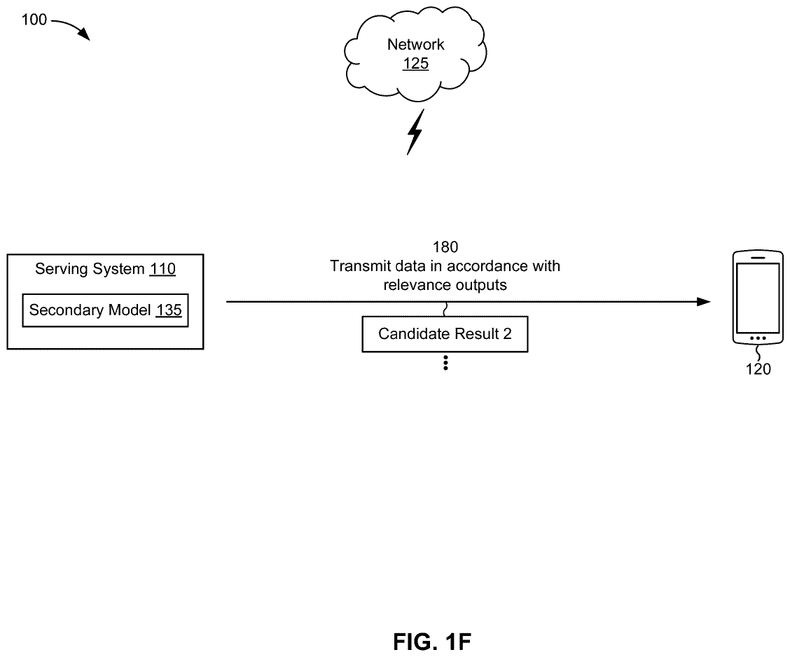

FIGS. 1A-1F illustrate an example environment 100 for deployment of a secondary model for online, low-latency applications. As shown, the environment 100 includes an offline system 105, a serving system 110, a data node 115, a user device 120, and a network 125.

Communication among the devices and systems of environment 100 may be performed via the network 125. The network 125 may include one or more wired and/or wireless networks. For example, the network 125 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. In some implementations, where the offline system 105 and the serving system 110 are components of the same higher-level system, the offline system 105 and the serving system 110 may communicate without use of the network 125.

The data node 115 may include storage, one or more data sources, one or more data services (e.g., accessible via an application programming interface (API)), and/or one or more databases, among other examples. The data node 115 may include, or may be included in, one or more servers. The data node 115 may store information relating to labeled training data, raw data logs for a search system, and/or frequently-used request-result pairs, among other examples. The data node 115 may provide any of the aforementioned information to the offline system 105 and/or to the serving system 110 (e.g., via the network 125). In some implementations, communications of the data node 115 with the offline system 105 and/or the serving system 110 may be performed locally (e.g., within a cloud computing environment) rather than through the network 125.

The user device 120 may include a communication device and/or a computing device. For example, the user device 120 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 120 may implement a user interface facilitating user-computer interaction and communication, and may include display screens, keyboards, a mouse, and the appearance of a desktop. For example, a user interface may include a way a user interacts with an application or a website. The user device 120 may exchange data with the serving system 110. For example, data exchanged with the serving system 110 may be in connection with the user device 120 accessing a web page using a web browser installed on the user device 120.

The offline system 105 may include a communication device and/or a computing device. For example, the offline system 105 may include one or more physical servers, one or more virtual servers (e.g., executing on computing hardware), and/or cloud computing resources (e.g., executing on computing hardware used in a cloud computing environment). “Offline” may refer to an environment in which the execution of data processing tasks is performed independently from real-time user inputs.

The serving system 110 may include a communication device and/or a computing device. For example, the serving system 110 may include one or more physical servers, one or more virtual servers (e.g., executing on computing hardware), and/or cloud computing resources (e.g., executing on computing hardware used in a cloud computing environment). In some implementations, the serving system 110 may be implemented on an edge node of a network or of a cloud system (e.g., in a regional data center of the cloud system). In some implementations, the serving system 110 may be a component (e.g., a hardware component or a software component) of the user device 120. The serving system may be configured to manage request traffic from user devices 120 made via the network 125. The serving system 110 may be an online system. “Online” may refer to an environment in which the execution of data processing tasks are performed in response to real-time user inputs. For example, the serving system 110 may provide responses to requests from user devices 120 in real time. “Real time” may refer to the responses being provided within a time frame (e.g., within 2 seconds, within 1 second, or within 100 milliseconds) that is perceptibly concurrent or near-concurrent with the requests.

In some implementations, communications between the offline system 105 and the serving system 110 may be performed through the network 125. For example, the offline system 105 may be a centralized processing system located on dedicated server(s) or cloud computing environment(s) that have a significant amount of computing resources, to perform the actions described below, that are not available or at least cannot be routinely utilized by the serving system 110 in the same way. The offline system 105 may communicate with and perform the same role for multiple serving systems 110 that may be distributed in different geographic areas and/or communicate with different groups of user devices 120. In this way, the offline system 105 may reduce the processing resources that are utilized compared to, for example, each serving system 110 having to have the same actions performed by a dedicated offline system.

In other implementations, communications between the offline system 105 and the serving system 110 may be performed locally (e.g., within a cloud computing environment) rather than through the network 125. For example, the offline system 105 and the serving system 110 may be implemented in the same cloud computing resource or in separate cloud computing resources within the same cloud computing environment. In some implementations, the offline system 105 and the serving system 110 may be components (e.g., co-located components or distributed components) of the same higher-level processing system. For example, the offline system 105 and the serving system 110 may be hardware components or software components of the same system.

The offline system 105 may perform training of a primary model 130 (also referred to as a “teacher model”) and a secondary model 135 (also referred to as a “student model”). The primary model 130 and the secondary model 135 may be machine learning models. The secondary model 135 may be based on a large language model (LLM) that is significantly smaller than an LLM of the primary model 130 (e.g., in terms of parameters), such as 60 times smaller or more. A “large language model” or “LLM” may refer to a computational system designed to understand and generate human language through learning patterns in vast amounts of training data, such as books, websites, and other sources.

The offline system 105 may train the secondary model 135 through capability transfer from the primary model 130. For example, the training of the secondary model 135 may be based on knowledge distillation from the primary model 130. This knowledge distillation may involve training the primary model 130, and training the secondary model 135 to mimic the results of the primary model 130. For example, the knowledge distillation described herein may enable distilling an LLM of the primary model 130 into an LLM of the secondary model 135, such that the secondary model 135 provides reliable outputs while maintaining high efficiency (e.g., the secondary model 135 may include an LLM that is at least as effective as the LLM of the primary model 130). In this way, the smaller secondary model 135 resolves latency issues that generally prevent LLMs from being utilized in real-time systems.

Thus, the secondary model 135 can be deployed in the serving system 110 to handle requests (e.g., network requests) from user devices and return relevant results (e.g., the secondary model 135 may be a ranking model for search queries). A request may include information indicating data (e.g., a type of data) that the user device 120 wants. For example, a request may include a query (e.g., a search query), which may be information (e.g., text, such as a word or a phrase) used to retrieve information from an information retrieval system (e.g., a search system). For example, a query may be text entered into a search input of a web page. A “candidate result” may refer to a result that has the potential to be responsive to (e.g., relevant to) a request. For example, the candidate result may be an electronic document (e.g., a web page) or an item (e.g., that is described in an electronic document). Thus, for a given request q and candidate result d, their predicted relevance by the primary model 130 may be denoted t(q, d)∈ [symbol] and their predicted relevance by the secondary model 135 may be denoted s(q, d)∈ [symbol] .

As shown in FIG. 1A, and by reference number 150, the offline system 105 may receive a labeled dataset from the data node 115 (e.g., via the network 125). A “labeled dataset” refers to a dataset that includes both input data and corresponding correct output labels used in supervised learning for a machine learning model. The labeled dataset may include a plurality of request-result pairs and soft relevance labels (also referred to herein as “soft targets”) for the request-result pairs. A “soft relevance label” may refer to a probabilistic value that indicates relative relevance (e.g., rather than a binary classification) in order to provide guidance to the secondary model 135. Each request-result pair may include a combination (e.g., a concatenation) of a request (e.g., the textual content of the request) and a set of data fields for a single candidate result (e.g., a request-result pair is a text string). The set of data fields may indicate metadata relating to a candidate result (e.g., relating to an item described in an electronic document). For example, the set of data fields may include an item title field, an item type field, an item brand field, an item color field, an item gender field, and/or an item description field.

For the labeled dataset, each request-result pair (q, d) may be given a rating. For example, ratings may be 4 (e.g., excellent; perfect match), 3 (e.g., good; item with a mismatched attribute), 2 (e.g., okay), 1 (e.g., bad; irrelevant), or 0 (e.g., embarrassing). The ratings may be mapped to classes (e.g., Class 2, Class 1, and Class 0), thereby providing a class label for each request-result pair (q, d). For example, rating 4 may be mapped to Class 2, rating 3 may be mapped to Class 1, and ratings 2, 1, and 0 may be mapped to Class 0. The relevance prediction may be formulated as a binary classification problem with soft targets. Thus, the classes may be mapped to soft targets. For example, Class 2 may be mapped to a soft target value of 1, Class 1 may be mapped to a soft target value of 0.5, and Class 0 may be mapped to a soft target value of 0. In this way, the soft targets can be converted from the editorial rating labels.

As shown by reference number 152, the offline system 105 may execute a process for adjusting parameters of the primary model 130. For example, the offline system 105 may train the primary model 130 to determine relevance (e.g., a level of relevance) between requests and candidate results. The offline system 105 may train the primary model 130 using the labeled dataset. Request-result pairs in the labeled dataset that are inputted into the primary model 130 may be tokenized. The primary model 130 may include an LLM that is fine-tuned using a cross-encoder architecture to predict the relevance between a request and a candidate result. The primary model 130 may be trained as a classification model using request-result pairs as inputs along with soft relevance labels. Classification may be based on the “last token,” where the hidden state of this last token is used as the representation of a request-result pair. The primary model may include a multilayer perceptron (MLP) layer to transform this representation into a single output value, which represents the predicted relevance score, t(q, d), of the primary model 130. The primary model 130 may be trained using cross-entropy loss, as defined by [symbol] _{teacher}(q) for each request q:

$${ℒ}_{teacher} ( q ) = {\sum }_{d ∈ {D}_{q}} [ - {y}_{q , d} \cdot log t ( q , d ) - ( 1 - {y}_{q , d} ) \cdot log ( 1 - t ( q , d ) ) ]$$

where D_{q} is the total candidate result collection for request q, and y_{q,d} is the soft label for request q and candidate result d (e.g., y_{q,d}∈{0, 0.5, 1}). The objective of the training may be to optimize t(q, d) by minimizing the loss function.

In some implementations, as shown by reference number 154, the offline system 105 may generate an unlabeled dataset for training the secondary model 135. For example, the labeled dataset may provide insufficient training data for the secondary model 135. Moreover, the labeled dataset may lack sufficient negative-label examples and/or may include incorrect labels, thereby affecting its usability for training the secondary model 135. The offline system 105 may receive raw log data (e.g., request log data associated with the serving system 110) from the data node 115, and the offline system 105 may generate the unlabeled dataset using raw log data. For example, the offline system 105 may generate the unlabeled dataset using a plurality of historical requests (e.g., made at the serving system 110) and a plurality of retrieval sets of candidate results associated with the historical requests. For example, each historical request may be associated with a set of relevant candidate results, retrieved from a total set of candidate results (e.g., an entire item catalog), that form a retrieval set for that request. The offline system 105 may generate a plurality of request-result pairs based on the historical requests and the retrieval sets. Accordingly, the unlabeled dataset may include this plurality of request-result pairs without labels (e.g., without soft relevance labels, as in the case of the labeled dataset).

As shown by reference number 156, the offline system 105 may execute a process for adjusting parameters of the secondary model 135. For example, the offline system 105 may train the secondary model 135 using the unlabeled dataset. Using the much larger unlabeled dataset improves the training of the secondary model 135 compared to training the secondary model 135 based on the smaller labeled dataset, thereby improving the accuracy and reliability of the secondary model 135. The training of the secondary model 135 may be based on knowledge distillation from the primary model 130. Knowledge distillation may be used to train the secondary model 135 to mimic the outputs of the primary model 130.

The knowledge distillation may use a margin-based loss function (e.g., a margin MSE loss function) on all candidate result pairs (i.e., a pair of candidate results) for a given request (e.g., not merely relevant-irrelevant candidate result pairs for the request). Using margin MSE to align the margins predicted by the secondary model 135 with that of the primary model 130 significantly improves knowledge distillation compared to using pointwise cross-entropy loss (e.g., even when both the primary model 130 and the secondary model 135 have cross-encoder architectures). As an example, the secondary model 135 may be trained to mimic the margin between a pair of candidate results that is predicted by the primary model 130. Rather than distilling knowledge by directly optimizing raw scores for each request-result pair, margin MSE loss uses the margin between pairs of candidate results for each request, thereby facilitating effective training using unlabeled data (e.g., where all request-result pairs do not have known true labels, such as “relevant” or “irrelevant”). In this way, the secondary model 135, trained using the margin-based loss function, is capable of providing more relevant and accurate outputs.

The offline system 105 may train the secondary model 135 using the unlabeled dataset as input into the primary model 130 and into the secondary model 135, and using the margin-based loss function (e.g., the margin MSE loss function), as shown in FIG. 1B. In particular, FIG. 1B illustrates a framework for training the secondary model 135 using knowledge distillation from the primary model 130. In some implementations, the primary model 130 and the secondary model 135 may have cross-encoder architectures.

Training the secondary model 135 using the primary model 130 may involve inputs of a request 160 (q), a first candidate result 162 (dᵢ), and a second candidate result 164 (dⱼ). The first candidate result 162 and the second candidate result 164 may include any pair of candidate results from a collection of candidate results, such as a retrieval set for the request 160. For example, the first candidate result 162 and the second candidate result 164 do not need to include one relevant candidate result to the request 160 and one irrelevant candidate result to the request 160. As shown, the primary model 130 and the secondary model 135 may be applied to the request 160 and the first candidate result 162 (e.g., a request-result pair that is a combination of the request 160 and the set of data fields for the first candidate result 162, as described herein), and a mirrored primary model 130 and secondary model 135 may be applied to the request 160 and the second candidate result 164 (e.g., a request-result pair that is a combination of the request 160 and the set of data fields for the second candidate result 164, as described herein).

The primary model 130 may include a language model component 131 (e.g., an LLM) as encoder. For example, the language model component 131 may be a bidirectional-encoder-representations-from-transformers model. In some implementations, the language model component 131 may utilize one billion or more parameters. For example, the language model component 131 may utilize approximately seven billion parameters. The output of the language model component 131 may be a multi-dimensional vector, which represents a request-result pair. The multi-dimensional vector output of the language model component 131 may be input to an MLP component 132 of the primary model 130. The MLP component 132 may output a single number representing a prediction of a level of relevance for the request-result pair (e.g., a relevance of the candidate result to the request). This single number prediction can be converted to a 0 to 1 scale (e.g., using a sigmoid function). The single output may enhance the effectiveness of the knowledge distillation.

The secondary model 135 may include a language model component 136 (e.g., an LLM) as encoder. For example, the language model component 136 may be a bidirectional-encoder-representations-from-transformers model. The language model component 136 of the secondary model 135 may use fewer parameters than the language model component 131 of the primary model 130. In some implementations, the language model component 136 may utilize 150 million or fewer parameters. For example, the language model component 136 may utilize approximately 110 million parameters. As a result of the techniques described herein, additional model capacity may not be necessary for successful knowledge distillation. A request-result pair may be input to the secondary model 135 using a CLS token, which may refer to a classification token added at the beginning of the request-result pair sequence. The language model component 136 may output a representation, such as a multi-dimensional vector or embedding, of the input tokens. After the encoder pass, the hidden state of the CLS token is used as a representation of the request-result pair. An MLP component 137 is then applied to this hidden state. In some implementations, an output of the MLP component 137 may be provided to a dropout layer 138 and then a classification head 139 before arriving at a final relevance output.

The secondary model 135 may be trained using a loss function 166 based on an output t(q, dᵢ) of the primary model 130, an output t(q, dⱼ) of the mirrored primary model 130, an output s(q, dᵢ) of the secondary model 135, and an output s(q, dⱼ) of the mirrored secondary model 135. The loss function 166 may compute a loss l(q, dᵢ, dⱼ) as:

$$l ( q , {d}_{i} , {d}_{j} ) = {( ( t ( q , {d}_{i} ) - t ( q , {d}_{j} ) ) - ( s ( q , {d}_{i} ) - s ( q , {d}_{j} ) ) )}^{2}$$

As an example, training the secondary model 135 using a margin MSE loss may include computing the margin MSE loss for all triplets (q, dᵢ, dⱼ), wherein dᵢ and dⱼ are candidate results from a collection (e.g., a retrieval set) for request q, denoted by D_{q}. |D_{q}| may denote the number of candidate results in D_{q}, and thereby the number of triplets may be represented as [D_{q}](|D_{q}|−1)/2. In contrast to other approaches that use triplets (q, d⁺, d⁻), where d⁺ and d⁻ are a relevant document and an irrelevant document, respectively, in accordance with relevance labels for training data, margin MSE enables knowledge distillation from large unlabeled datasets (e.g., that lack editorial labels). Using margin MSE, the goal during training of the secondary model 135 is to minimize a difference between (e.g., make as close as possible)

$${Δ}_{q , {d}_{i} , {d}_{j}}^{s}$$

$$and$$

$${Δ}_{q , {d}_{i} , {d}_{j}}^{t} ,$$

where

$${Δ}_{q , {d}_{i} , {d}_{j}}^{s}$$

$$and$$

$${Δ}_{q , {d}_{i} , {d}_{j}}^{t}$$

represent relevance score differences for the request-result pairs (q, dᵢ) and (q, dᵢ) from the secondary model 135 and the primary model 130, respectively. In particular,

$${Δ}_{q , {d}_{i} , {d}_{j}}^{s} = s ( q , {d}_{i} ) - s ( q , {d}_{j} )$$

$$and$$

$${Δ}_{q , {d}_{i} , {d}_{j}}^{t} = t ( q , {d}_{i} ) - t ( q , {d}_{j} ) .$$

The margin MSE loss function used by the secondary model 135 for request q may be defined as:

$${ℒ}_{student} ( q ) = \frac{2}{\vert {D}_{q} \vert ( \vert {D}_{q} \vert - 1 )} {\sum }_{\begin{matrix}{d}_{i} , {d}_{j} ∈ {D}_{q} , \\ 1 \leq i < j \leq \vert {D}_{q} \vert\end{matrix}} {( {Δ}_{q , {d}_{i} , {d}_{j}}^{t} - {Δ}_{q , {d}_{i} , {d}_{j}}^{s} )}^{2}$$

The margin MSE loss may be computed on all candidate result pairs from a candidate result collection for a given request, thereby eliminating the need for true labels.

For example, to train the secondary model 135, the offline system 105 may sample (e.g., randomly or without restriction), for a given request, any pair of candidate results (dᵢ, dⱼ) from the collection of candidate results and use the corresponding request-result pairs in the unlabeled dataset as input into the primary model 130 (e.g., into the primary model 130 and a mirror of the primary model 130) and into the secondary model 135 (e.g., into the secondary model 135 and a mirror of the secondary model 135). The primary model 130 and the secondary model 135 may output respective relevance outputs (e.g., relevance scores) for the request-result pairs of the unlabeled dataset. The relevance outputs from the primary model 130 effectively provide labels for request-result pairs that can be used in loss calculation. A relevance output of a request-result pair may indicate a level of relevance between a request and a candidate result that make up the request-result pair. In some implementations, a relevance output may be a value between 0 and 1, inclusive.

The offline system 105 may apply the margin MSE loss function to the relevance outputs from the primary model 130 and the relevance outputs from the secondary model 135 to determine a loss value. For example, the margin MSE loss function may be based on a difference between first relevance outputs of the primary model 130 for a first request-result pair and a second request-result pair for the given request, and a difference between second relevance outputs of the secondary model for the first request-result pair and the second request-result pair for the given request. Because the pair of candidate results may be sampled from any two documents in the collection, the first request-result pair and the second request-result pair may relate to a pair of relevant candidate results to the given request (e.g., both candidate results are relevant to the request), or may relate to a pair of irrelevant candidate results to the given request (e.g., both candidate results are irrelevant to the request). In other words, it is not required for the sampling to select one relevant candidate result and one irrelevant candidate result, although this may occur by chance in some cases. The offline system 105 may perform this process iteratively for all pairs of candidate results (e.g., every pairwise combination) from the collection of candidate results for the given request in order to determine an overall loss value. The offline system 105 may adjust parameters of the secondary model 135 based on the overall loss value or the individual loss values for each pair of candidate results (e.g., using backpropagation), with the goal of minimizing the loss value.

In some implementations, the unlabeled dataset input into the primary model 130 may include request-result pairs based on the set of data fields, and the unlabeled dataset input into the secondary model 135 may include request-result pairs based on a smaller subset of the set of data fields (i.e., a subset smaller in size than the set of data fields). For example, the request-result pairs in the unlabeled dataset used for the primary model 130 may include a long text field (e.g., of 150 characters or more), such as an item description field, whereas the request-result pairs in the unlabeled dataset used for the secondary model 135 may not include the long text field. In some implementations, the offline system 105 may generate a first version of the unlabeled dataset using the entire set of data fields for the primary model 130, and generate a second version of the unlabeled dataset using the smaller subset of data fields for the secondary model 135. The first version and the second version of the unlabeled dataset may be generated prior to being input into the primary model 130 and the secondary model 135, respectively, or may be generated in real time as they are input into the primary model 130 and the secondary model 135. In some other examples, the offline system 105 may train the secondary model 135 using the same version of the unlabeled dataset as inputs into the primary model 130 and the secondary model 135 (e.g., the number of input features may be the same for the primary model 130 and the secondary model 135).

In some examples, the offline system 105 may input the unlabeled dataset into the primary model 130 and into the secondary model 135 concurrently during training of the secondary model 135. In some other examples, prior to training the secondary model 135, the offline system 105 may input the unlabeled dataset into the primary model 130 to obtain relevance outputs, and then label the request-result pairs of the unlabeled dataset using the relevance outputs to obtain an artificially-labeled dataset (e.g., a dataset labeled by the primary model 130 rather than a human). The artificially-labeled dataset can be used for comparison to relevance outputs of the secondary model 135 and computation of a loss value during training of the secondary model 135.

As shown in FIG. 1C, and by reference number 170, the offline system 105, or its higher-level system, may deploy the secondary model 135 in the serving system 110, thereby enabling the serving system 110 to handle requests (e.g., real-time requests) using the secondary model 135. Deploying the secondary model 135 may include converting the secondary model 135 into a deployment format, such as by transforming the secondary model's parameters and architecture into a binary format. Deploying the secondary model 135 may also include loading (e.g., installing) dependencies and libraries for the secondary model 135 in the serving system 110. Deploying the secondary model 135 may further include loading (e.g., installing) the secondary model 135 (e.g., in the deployment format) in the serving system 110. In some implementations, the serving system 110 may implement an API used to handle incoming requests and pass them to the secondary model 135 for inference. The API may be existing at a time of the deployment of the secondary model 135, or deploying the secondary model 135 may include configuring and loading API components for the secondary model 135.

Once the trained secondary model 135 is deployed to the serving system 110, the serving system 110 may use the trained secondary model 135 to handle incoming requests. As shown by reference number 172, the serving system 110 may receive, from the user device 120, a request (e.g., indicating a search query). For example, the request from the user device 120 may be a network request in a network message, such as an HTTP request. In some implementations, the request may indicate a query, such as a “tail query.” Search queries are often segmented into head, torso, and tail queries. Head and torso queries generally provide enough engagement data to train machine learning models for retrieving and reranking relevant items. However, it is difficult to effectively retrieve and rerank the most relevant documents for tail queries due to the lack of engagement data.

In connection with the request from the user device 120, the serving system 110 may receive information regarding the user device 120 (e.g., the request may include the information). The information regarding the user device 120 may indicate a technical platform of the user device 120, such as information indicating a hardware model number or generation of the user device 120, a display size of the user device 120, a display resolution of the user device 120, a processor type of the user device 120, an operating system of the user device 120, and/or an application used by the user device 120 to transmit the request (e.g., a dedicated mobile application that is for a particular type of mobile operating system and is configured to specifically interact with the serving system 110, a mobile web browser, a desktop web browser, etc.), among other examples. In some examples, the information regarding the user device 120 may indicate interactions of the user device 120 (e.g., interactions with user interface elements of the serving system 110, resources accessed in the serving system 110, or the like).

As shown in FIG. 1D, and by reference number 174, in a retrieval stage of processing the request, the serving system 110 may determine, based on the request, a retrieval set (e.g., a recall set) that includes a plurality of candidate results. The retrieval set may be a smaller subset from a collection of candidate results. For example, the collection of candidate results may include all candidate results (e.g., all items in a catalog), and the retrieval set may include less than all the candidate results from the collection. The candidate results in the retrieval set may be ranked, but this may be a preliminary ranking for the candidate results. In some implementations, the serving system 110 may determine the retrieval set (e.g., the retrieval set and its preliminary ranking) based on keyword matching, or another simple, low-latency technique for determining initial candidate results for the request.

As shown by reference number 176, the serving system 110 may generate a plurality of request-result pairs based on the request and the retrieval set, which can be used as an input for the secondary model 135. For example, each request-result pair may include a combination (e.g., a concatenation) of the request and a smaller subset of data fields for a respective candidate result of the retrieval set (e.g., the combination thus enabling the secondary model 135 to benefit from the attention mechanism across all tokens in the input). The smaller subset of data fields may be a smaller subset of the set of data fields used for training the primary model 130 (e.g., lacking a long text field, such as an item description field), as described herein. By using a smaller subset of data fields, the serving system 110 processes much less data using when using the secondary model 135, thereby conserving significant processing resources and power.

In some implementations, a request-result pair for inputting to the secondary model 135 (e.g., at inference or during training) may include the request (e.g., textual content of the request) concatenated with the smaller subset of data fields, where the request is separated from the data fields by a separator token and the data fields are separated from each other by separator tokens. Each separator token may be a distinct and unused token in a vocabulary of the language model component 136 of the secondary model 135. For example, a request-result pair for inputting to the secondary model 135 may be in the form:
[CLS] query [SEPₜ] title [SEPₚ] type [SEP_{b}] brand [SEP_{c}] color [SEP_{g}] gender
   where [CLS] is a classification token added at the beginning of the request-result pair sequence and representative of the entire sequence (e.g., representative of the request-result pair), [SEPₜ], [SEPₚ], [SEP_{b}], [SEP_{c}], and [SEP_{d}] represent distinct and unused separator tokens, and title, type, brand, color, and gender represent data fields.

As shown in FIG. 1E, and by reference number 178, in a ranking stage of processing the request (also referred to as a “re-ranking stage”), the serving system 110 may input the generated request-result pairs (e.g., embeddings representing the request-result pairs) into the secondary model 135 to obtain relevance outputs for the request-result pairs. For example, a relevance output (e.g., a relevance score) for a request-result pair may indicate a level of relevance of the candidate result, of the request-result pair, to the request. Accordingly, the serving system 110 may generate a relevance ranking (e.g., a re-ranking, relative to the initial ranking of the retrieval set) of the request-result pairs (e.g., a ranking of the request-result pairs from most relevant to least relevant) based on the relevance outputs.

As shown in FIG. 1F, by reference number 180, the serving system 110 may transmit, in accordance with the relevance outputs (e.g., in accordance with the relevance ranking), a response indicating data for presentation in a user interface of the user device 120. The response may be a network response in a network message, such as an HTTP response. The data may indicate one or more candidate results (e.g., at least a most-relevant candidate result). In some implementations, the data may be formatted as search results for presentation in a web page. In some implementations, the relevance outputs may be one of multiple features used by the serving system 110 to determine a final relevance ranking of the candidate results. For example, the serving system 110 may determine the final relevance ranking based on the relevance outputs and the information regarding the user device 120.

As an example, the information regarding the user device 120 may indicate interactions of the user device 120 (e.g., clicks) with user interface elements (e.g., representing candidate results) in the serving system 110. Accordingly, the serving system 110 may determine the final relevance ranking based on the relevance outputs and the relevance of candidate results to the interactions of the user device 120 (e.g., relevance of the candidate results to previous candidate results that the user device 120 has had interactions with).

Additionally, or alternatively, the information regarding the user device 120 may include, for example, whether the user device 120 used a first type of mobile application for a first type of mobile operating system, a second type of mobile application for a second type of mobile operating system, a first type of mobile browser for the first type of mobile operating system, a second type of mobile browser for a second type of mobile operating system to generate the request, and/or a particular type of browser for a desktop computer. For example, different candidate results may be relevant to, or suitable for, different technical platforms and/or different interaction histories. As an example, if the user device 120 is using the first type of mobile application, then the serving system 110 may determine the final relevance ranking based on relevance to the first type of mobile application. Continuing with the example, the serving system 110 may determine a different final relevance ranking for the second type of mobile application.

In some implementations, based on a use of the secondary model 135 in the serving system 110, the offline system 105, the serving system 110, or their higher-level system, may collect data relating to usage counts for request-result pairs. For example, a usage count may indicate the number of times that a particular request-result pair has been input into the secondary model 135 in connection with request processing at the serving system 110. The offline system 105 may then identify one or more frequently-used request-result pairs associated with a request (e.g., based on the usage counts for request-result pairs). For example, the offline system 105 may identify a frequently-used request-result pair based on its usage count satisfying a threshold. Based on identifying the frequently-used request-result pair(s), the offline system 105 may input the frequently-used request-result pair(s) into the secondary model 135 to obtain relevance outputs for the frequently-used request-result pair(s). The offline system 105 may store these relevance outputs, in association with the frequently-used request-result pair(s), in a cache (e.g., of data node 115).

In some implementations, the request received by the serving system 110 at reference number 172 may be the same as the request associated with the frequently-used request-result pair(s). Here, in response to receiving the request, the serving system 110 may retrieve the relevance outputs for the frequently-used request-result pair(s) from the cache. The cached relevance outputs minimize the need for real-time computation, thereby reducing repetitive processing in the serving system 110 and conserving processing resources. In some examples, each candidate result in a retrieval set for the request may have a corresponding frequently-used request-result pair and relevance output retrieved from the cache. Accordingly, the serving system 110 may determine a relevance ranking for request-result pairs from the retrieval set for the request using the relevance outputs retrieved from the cache, and without using the secondary model 135. In some other examples, the serving system 110 may identify one or more request-result pairs from the retrieval set for the request that do not have corresponding frequently-used request-result pairs and relevance outputs in the cache. Accordingly, the serving system 110 may invoke the secondary model 135 and input these request-result pairs into the secondary model 135 to obtain supplemental relevance outputs for the request-result pairs. The serving system 110 may then determine a relevance ranking for request-result pairs from the retrieval set for the request using relevance outputs retrieved from the cache (for those request-result pairs with corresponding relevance outputs in the cache) and the supplemental relevance outputs obtained from the secondary model 135 (for those request-result pairs without corresponding relevance outputs in the cache).

The techniques described herein facilitate training of the secondary model 135 using an unlabeled dataset, which can be much larger than the labeled dataset used to train the primary model 130. The large unlabeled dataset, when used with the margin-based loss function that accounts for the lack of true labels in the unlabeled dataset, improves the training of the secondary model 135. Accordingly, the secondary model 135 may be capable of producing relevant and accurate outputs, that match or exceed those of the primary model 130, while being able to satisfy the low-latency requirements of online, low-latency applications of the serving system 110 due to being significantly smaller than the primary model 130. The relevant and accurate outputs produced by the secondary model 135 enable the serving system 110 to respond to requests from user devices with accurate, high-quality data that satisfies the user devices' requests. By doing so, fewer requests and responses are exchanged in network messages between the serving system and user devices, thereby conserving significant processing resources and network resources. Furthermore, the secondary model 135 is capable of producing relevant and accurate outputs even when fewer data fields (e.g., relative to the amount of data fields used in training of the primary model 130) are provided to the secondary model 135 as input. Thus, through reducing the amount of input data that is needed by the secondary model 135 in order to produce relevant and accurate outputs, the serving system 110 is able to conserve significant processing resources and power.

As indicated above, FIGS. 1A-1F is provided as an example. Other examples may differ from what is described with regard to FIGS. 1A-1F.

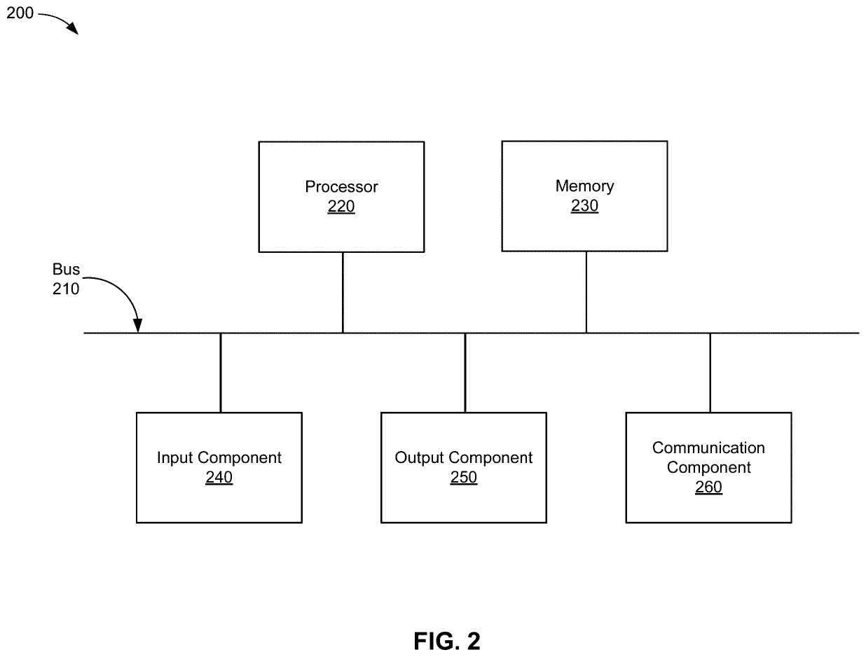

FIG. 2 is a diagram of example components of a device 200 associated with deployment of a secondary model for online, low-latency applications. The device 200 may correspond to the offline system 105, serving system 110, data node 115, and/or user device 120. In some implementations, offline system 105, serving system 110, data node 115, and/or user device 120 may include one or more devices 200 and/or one or more components of the device 200. As shown in FIG. 2, the device 200 may include a bus 210, a processor 220, a memory 230, an input component 240, an output component 250, and/or a communication component 260. The bus 210, the processor 220, the memory 230, the input component 240, the output component 250, and/or the communication component 260 may provide means for performing one or more operations described herein.

The bus 210 may include one or more components that enable wired and/or wireless communication among the components of the device 200. The bus 210 may couple together two or more components of FIG. 2, such as via operative coupling, communicative coupling, electronic coupling, and/or electric coupling. For example, the bus 210 may include an electrical connection (e.g., a wire, a trace, and/or a lead) and/or a wireless bus. The processor 220 may include a central processing unit, a graphics processing unit, a microprocessor, a controller, a microcontroller, a digital signal processor, a field-programmable gate array, an application-specific integrated circuit, and/or another type of processing component. The processor 220 may be implemented in hardware, firmware, or a combination of hardware and software. In some implementations, the processor 220 may include one or more processors capable of being programmed to perform one or more operations or processes described elsewhere herein.

The memory 230 may include volatile and/or nonvolatile memory. For example, the memory 230 may include random access memory (RAM), read only memory (ROM), a hard disk drive, and/or another type of memory (e.g., a flash memory, a magnetic memory, and/or an optical memory). The memory 230 may include internal memory (e.g., RAM, ROM, or a hard disk drive) and/or removable memory (e.g., removable via a universal serial bus connection). The memory 230 may be a non-transitory computer-readable medium. The memory 230 may store information, one or more instructions, and/or software (e.g., one or more software applications) related to the operation of the device 200. In some implementations, the memory 230 may include one or more memories that are coupled (e.g., communicatively coupled) to one or more processors (e.g., processor 220), such as via the bus 210. Communicative coupling between a processor 220 and a memory 230 may enable the processor 220 to read and/or process information stored in the memory 230 and/or to store information in the memory 230.

The input component 240 may enable the device 200 to receive input, such as user input and/or sensed input. For example, the input component 240 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 250 may enable the device 200 to provide output, such as via a display, a speaker, and/or a light-emitting diode. The communication component 260 may enable the device 200 to communicate with other devices via a wired connection and/or a wireless connection. For example, the communication component 260 may include a receiver, a transmitter, a transceiver, a modem, a network interface card, and/or an antenna.

The device 200 may perform one or more operations or processes described herein. For example, a non-transitory computer-readable medium (e.g., memory 230) may store a set of instructions (e.g., one or more instructions or code) for execution by the processor 220. The processor 220 may execute the set of instructions to perform one or more operations or processes described herein. In some implementations, execution of the set of instructions, by one or more processors 220, causes the one or more processors 220 and/or the device 200 to perform one or more operations or processes described herein. In some implementations, hardwired circuitry may be used instead of or in combination with the instructions to perform one or more operations or processes described herein. Additionally, or alternatively, the processor 220 may be configured to perform one or more operations or processes described herein. Thus, implementations described herein are not limited to any specific combination of hardware circuitry and software.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

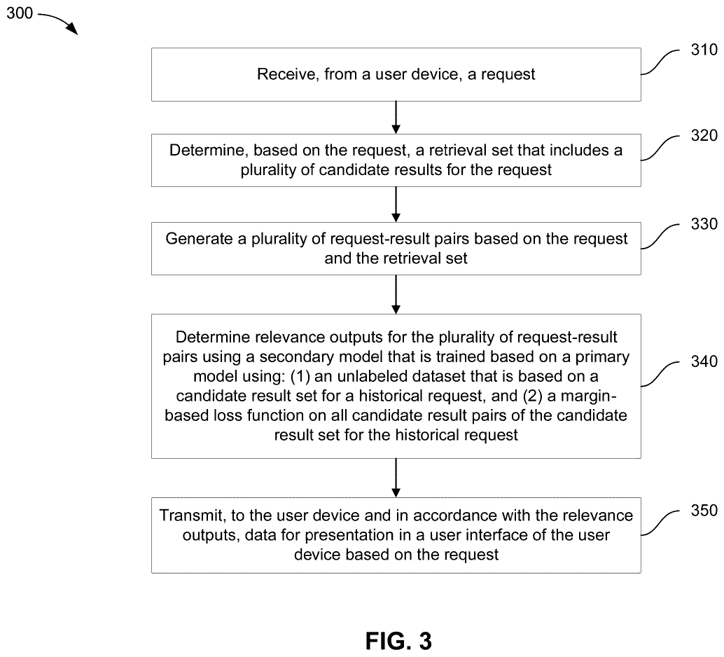

FIG. 3 is a flowchart of an example process 300 associated with managing request traffic in a serving system. In some implementations, one or more process blocks of FIG. 3 may be performed by a device that includes offline system 105 and/or serving system 110. In some implementations, one or more process blocks of FIG. 3 may be performed by another device or a group of devices separate from or including the device, such as data node 115 and/or user device 120. Additionally, or alternatively, one or more process blocks of FIG. 3 may be performed by one or more components of the device 200, such as processor 220, memory 230, input component 240, output component 250, and/or communication component 260.

At step 310, process 300 may include receiving, from a user device, a request. For example, the device may receive a request, as described herein. As an example, the request may indicate a search query.

At step 320, process 300 may include determining, based on the request, a retrieval set that includes a plurality of candidate results for the request. For example, the device may determine, based on the request, a retrieval set that includes a plurality of candidate results for the request, as described herein. The retrieval set may be a smaller subset of all possible candidate results, and may represent an initial set of candidate results for the request.

At step 330, process 300 may include generating a plurality of request-result pairs based on the request and the retrieval set. For example, the device may generate a plurality of request-result pairs based on the request and the retrieval set, as described herein. The request-result pairs provide the request and the candidate results of the retrieval set in a format that can be more easily processed by a model. In some implementations, the request-result pairs may be represented as embeddings.

At step 340, process 300 may include determining relevance outputs for the plurality of request-result pairs using a secondary model that is trained based on a primary model using: (1) an unlabeled dataset that is based on a candidate result set for a historical request, and (2) a margin-based loss function on all candidate result pairs of the candidate result set for the historical request. For example, the device may determine relevance outputs for the plurality of request-result pairs using a secondary model, as described herein. Based on the training using the unlabeled dataset and the margin-based loss function, the secondary model may have improved performance and may be capable of producing high-quality outputs.

At step 350, process 300 may include transmitting, to the user device and in accordance with the relevance outputs, data for presentation in a user interface of the user device based on the request. For example, the device may transmit, to the user device and in accordance with the relevance outputs, data for presentation in a user interface of the user device based on the request, as described herein. As an example, the data may include one or more candidate results (e.g., in accordance with the relevance outputs) formatted in HTML, or other markup or code.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

By training the secondary model 135 using an unlabeled dataset (which can be much larger than the labeled dataset used to train the primary model 130) and the margin-based loss function, the secondary model 135 is able to achieve an efficacy that matches or exceeds that of the primary model 130. Because the secondary model 135 is much smaller than the primary model 130, but still as accurate, the secondary model 135 may be deployed in the serving system 110 to handle request traffic from user devices 120 while satisfying the low-latency requirements of online, low-latency applications of the serving system 110. Moreover, by producing relevant and accurate outputs with low latency, the secondary model 135 enables the serving system 110, which is communicatively connected to user devices 120 via a network, to respond to request traffic from the user devices 120 in real time with accurate, high-quality data that satisfies the user devices' requests. By doing so, fewer requests and responses are exchanged in network messages between the serving system and the user devices 120, thereby conserving significant processing resources and network resources. Furthermore, due to the way that the secondary model 135 is trained, the performance of the secondary model 135 is not affected even when fewer data fields (e.g., relative to the amount of data fields used in training of the primary model 130) are provided to the secondary model 135 as input. Reducing the number of data fields used as input significantly reduces the processing resources and power consumed by the serving system 110, while also reducing latency to achieve performance suitable for the online, low-latency applications of the serving system 110.

The present techniques will be better understood with reference to the following enumerated aspects:
1. A method of managing request traffic in a serving system.
2. The method of aspect 1, comprising: receiving, by a device of the serving system and from a user device, a request; determining, by the device and based on the request, a retrieval set that includes a plurality of candidate results for the request; generating, by the device, a plurality of request-result pairs based on the request and the retrieval set; determining, by the device, relevance outputs for the plurality of request-result pairs using a secondary model that is trained based on a primary model using: (1) an unlabeled dataset that is based on a candidate result set for a historical request, and (2) a margin-based loss function on all candidate result pairs of the candidate result set for the historical request; and transmitting, by the device to the user device and in accordance with the relevance outputs, data for presentation in a user interface of the user device based on the request.
3. The method of any of aspects 1-2, wherein determining the relevance outputs for the plurality of request-result pairs using the secondary model comprises: inputting the plurality of request-result pairs into the secondary model, wherein a request-result pair, of the plurality of request-result pairs, comprises a combination of the request and a subset of a set of data fields used to train the primary model that is smaller in size than the set of data fields.
4. The method of any of aspects 1-3, further comprising: identifying, by the device, one or more frequently-used request-result pairs associated with the request; inputting, by the device, the one or more frequently-used request-result pairs into the secondary model to obtain frequently-used relevance outputs for the one or more frequently-used request-result pairs; storing, by the device, the frequently-used relevance outputs for the one or more frequently-used request-result pairs in a cache; and retrieving, by the device and based on the request, the frequently-used relevance outputs for the one or more frequently-used request-result pairs from the cache.
5. The method of aspect 4, wherein determining the relevance outputs for the plurality of request-result pairs using the secondary model comprises: identifying one or more request-result pairs of the plurality of request-result pairs that correspond to the one or more frequently-used request-result pairs; and determining a relevance ranking for the plurality of request-result pairs using the relevance outputs and the frequently-used relevance outputs.
6. The method of any of aspects 1-5, wherein the primary model and the secondary model have cross-encoder architectures.
7. The method of any of aspects 1-6, further comprising: training, by the device, the primary model, using a labeled dataset, to determine relevance between requests and results, wherein the labeled dataset includes a plurality of first request-result pairs and labels for the plurality of first request-result pairs; receiving, by the device, raw log data indicating the historical request and the candidate result set for the historical request; generating, by the device, an unlabeled dataset that includes a plurality of second request-result pairs based on the historical request and the candidate result set for the historical request; and training, by the device, the secondary model, based on knowledge distillation from the primary model, using the unlabeled dataset as input to the primary model and to the secondary model, and using the margin-based loss function on all candidate result pairs in the candidate result set for the historical request.
8. The method of aspect 7, wherein the margin-based loss function is a margin mean squared error (MSE) loss function and wherein training the secondary model comprises: training the secondary model using the margin MSE loss function for (1) a difference between first relevance outputs from the primary model for a first request-result pair and a second request-result pair, of the plurality of second request-result pairs, for the historical request, and (2) a difference between second relevance outputs of the secondary model for the first request-result pair and the second request-result pair for the historical request.
9. The method of any of aspects 7-8, wherein the first request-result pair and the second request-result pair relate to a pair of relevant candidate results to the historical request or to a pair of irrelevant candidate results to the historical request.
10. The method of any of aspects 7-9, wherein generating the unlabeled dataset comprises generating a first version of the unlabeled dataset that indicates the plurality of second request-result pairs using a set of data fields, and a second version of the unlabeled dataset that indicates the plurality of second request-result pairs using a subset of the set of data fields that is smaller in size than the set of data fields, and wherein training the secondary model comprises training the secondary model using the first version of the unlabeled dataset as input to the primary model and using the second version of the unlabeled dataset as input to the secondary model.
11. One or more non-transitory, computer-readable mediums storing instructions that, when executed by a data processing apparatus, cause the data processing apparatus to perform operations comprising those of any of aspects 1-10.
12. A system comprising one or more processors; and memory storing instructions that, when executed by the processors, cause the processors to effectuate operations comprising those of any of aspects 1-10.
13. A system comprising means for performing any of aspects 1-10.

The foregoing disclosure provides illustration and description, but is not intended to be exhaustive or to limit the implementations to the precise forms disclosed. Modifications may be made in light of the above disclosure or may be acquired from practice of the implementations.

Although particular combinations of features are recited in the claims and/or disclosed in the specification, these combinations are not intended to limit the disclosure of various implementations. In fact, many of these features may be combined in ways not specifically recited in the claims and/or disclosed in the specification.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.”

What is claimed is:

1. A system for deploying a secondary model in a serving system that is configured to manage request traffic made in a network by user devices, comprising:
one or more memories; and
one or more processors, communicatively coupled to the one or more memories, configured to cause the system to:
receive, from one or more servers, raw log data indicating a historical request and a candidate result set corresponding to the historical request;
generate, based on the historical request and the candidate result set, a first version of an unlabeled dataset that indicates a plurality of request-result pairs using a set of data fields used to train a primary model, and a second version of the unlabeled dataset that indicates the plurality of request-result pairs using a subset of the set of data fields that is smaller in size than the set of data fields;
execute a process for adjusting parameters of a secondary model using the first version of the unlabeled dataset as input into the primary model to provide labels for the plurality of request-result pairs, using the second version of the unlabeled dataset as input into the secondary model, and using a margin-based loss function on all candidate result pairs of the candidate result set for the historical request; and
deploy, to the serving system, the secondary model for handling network requests from user devices.

2. The system of claim 1, wherein the one or more processors, to cause the system to execute the process for adjusting the parameters of the secondary model, are configured to cause the system to:
adjust the parameters of the secondary model using a margin mean squared error (MSE) loss function for (1) a difference between first relevance outputs from the primary model for a first request-result pair and a second request-result pair, of the plurality of request-result pairs, for the historical request, and (2) a difference between second relevance outputs of the secondary model for the first request-result pair and the second request-result pair for the historical request.

3. The system of claim 2, wherein the first request-result pair and the second request-result pair relate to a pair of relevant candidate results to the historical request or to a pair of irrelevant candidate results to the historical request.

4. The system of claim 1, wherein the one or more processors are further configured to cause the system to:
receive, from a user device, a network request;
determine, based on the network request, a retrieval set that includes a plurality of candidate results;
generate a plurality of responsive request-result pairs based on the network request and the retrieval set;
input the plurality of responsive request-result pairs into the secondary model to obtain relevance outputs for the plurality of responsive request-result pairs; and
transmit, to the user device and in accordance with the relevance outputs, a network response indicating data for presentation in a user interface of the user device based on the network request.

5. The system of claim 4, wherein the one or more processors are further configured to cause the system to:
identify one or more frequently-used request-result pairs associated with the network request;
input the one or more frequently-used request-result pairs into the secondary model to obtain relevance outputs for the one or more frequently-used request-result pairs; and
store the relevance outputs for the one or more frequently-used request-result pairs in a cache.

6. The system of claim 1, wherein the one or more processors are further configured to cause the system to:
train the primary model, using a labeled dataset, to determine relevance between requests and candidate results,
wherein the labeled dataset includes a plurality of labeled request-result pairs having soft relevance labels.

7. A method of managing request traffic in a serving system, comprising:
receiving, by a device of the serving system and from a user device, a request;
determining, by the device and based on the request, a retrieval set that includes a plurality of candidate results for the request;
generating, by the device, a plurality of request-result pairs based on the request and the retrieval set;
determining, by the device, relevance outputs for the plurality of request-result pairs using a secondary model that is trained based on a primary model using: (1) an unlabeled dataset that is based on a candidate result set for a historical request, and (2) a margin-based loss function on all candidate result pairs of the candidate result set for the historical request; and
transmitting, by the device to the user device and in accordance with the relevance outputs, data for presentation in a user interface of the user device based on the request.

8. The method of claim 7, wherein determining the relevance outputs for the plurality of request-result pairs using the secondary model comprises:
inputting the plurality of request-result pairs into the secondary model,
wherein a request-result pair, of the plurality of request-result pairs, comprises a combination of the request and a subset of a set of data fields used to train the primary model that is smaller in size than the set of data fields.

9. The method of claim 7, further comprising:
identifying, by the device, one or more frequently-used request-result pairs associated with the request;
inputting, by the device, the one or more frequently-used request-result pairs into the secondary model to obtain frequently-used relevance outputs for the one or more frequently-used request-result pairs;
storing, by the device, the frequently-used relevance outputs for the one or more frequently-used request-result pairs in a cache; and
retrieving, by the device and based on the request, the frequently-used relevance outputs for the one or more frequently-used request-result pairs from the cache.

10. The method of claim 9, wherein determining the relevance outputs for the plurality of request-result pairs using the secondary model comprises:
identifying one or more request-result pairs of the plurality of request-result pairs that correspond to the one or more frequently-used request-result pairs; and
determining a relevance ranking for the plurality of request-result pairs using the relevance outputs and the frequently-used relevance outputs.

11. The method of claim 7, wherein the primary model and the secondary model have cross-encoder architectures.

12. The method of claim 7, further comprising:
training, by the device, the primary model, using a labeled dataset, to determine relevance between requests and results,
wherein the labeled dataset includes a plurality of first request-result pairs and labels for the plurality of first request-result pairs;
receiving, by the device, raw log data indicating the historical request and the candidate result set for the historical request;
generating, by the device, an unlabeled dataset that includes a plurality of second request-result pairs based on the historical request and the candidate result set for the historical request; and
training, by the device, the secondary model, based on knowledge distillation from the primary model, using the unlabeled dataset as input to the primary model and to the secondary model, and using the margin-based loss function on all candidate result pairs in the candidate result set for the historical request.

13. The method of claim 12, wherein the margin-based loss function is a margin mean squared error (MSE) loss function and wherein training the secondary model comprises:
training the secondary model using the margin MSE loss function for (1) a difference between first relevance outputs from the primary model for a first request-result pair and a second request-result pair, of the plurality of second request-result pairs, for the historical request, and (2) a difference between second relevance outputs of the secondary model for the first request-result pair and the second request-result pair for the historical request.

14. The method of claim 13, wherein the first request-result pair and the second request-result pair relate to a pair of relevant candidate results to the historical request or to a pair of irrelevant candidate results to the historical request.

15. The method of claim 12, wherein generating the unlabeled dataset comprises generating a first version of the unlabeled dataset that indicates the plurality of second request-result pairs using a set of data fields, and a second version of the unlabeled dataset that indicates the plurality of second request-result pairs using a subset of the set of data fields that is smaller in size than the set of data fields, and
wherein training the secondary model comprises training the secondary model using the first version of the unlabeled dataset as input to the primary model and using the second version of the unlabeled dataset as input to the secondary model.

16. An apparatus, comprising:
means for generating an unlabeled dataset that includes a plurality of request-result pairs based on a historical request and a candidate result set associated with the historical request;
means for training a secondary model, based on a primary model, using the unlabeled dataset as input to the primary model and to the secondary model, and using a loss function on all candidate result pairs in the candidate result set for the historical request; and
means for deploying the secondary model for handling requests from user devices.

17. The apparatus of claim 16, further comprising:
means for receiving, from a user device, a request;
means for determining, based on the request, a retrieval set that includes a plurality of candidate results for the request;
means for generating a plurality of responsive request-result pairs based on the request and the retrieval set;
means for inputting the plurality of responsive request-result pairs into the secondary model to obtain relevance outputs for the plurality of responsive request-result pairs; and
means for transmitting, to the user device and in accordance with the relevance outputs, data for presentation in a user interface of the user device based on the request.

18. The apparatus of claim 17, wherein a request-result pair, of the plurality of responsive request-result pairs, comprises a combination of a request and a subset of a set of data fields used to train the primary model that is smaller in size than the set of data fields.

19. The apparatus of claim 16, further comprising:
means for training the primary model using a labeled dataset.

20. The apparatus of claim 16, wherein the loss function is a margin mean squared error (MSE) loss function, and wherein the means for training the secondary model comprise:
means for training the secondary model using the margin MSE loss function for (1) a difference between first relevance outputs from the primary model for a first request-result pair and a second request-result pair for the historical request, and (2) a difference between second relevance outputs of the secondary model for the first request-result pair and the second request-result pair for the historical request.
